(19) United States
(12) Patent Application Publication
(10) Pub. No.: US 2015/0169055 A1
(43) Pub. Date: Jun. 18, 2015

(54) Providing an Input for an Operating Element

(71) Applicant: Bayerische Motoren Werke Aktiengesellschaft, Muenchen (DE)

(72) Inventor: Hermann KUENZNER, Freising (DE)

(21) Appl. No.: 14/633,803

(22) Filed: Feb. 27, 2015

Related U.S. Application Data
(63) Continuation of application No. PCT/EP2013/067453, filed on Aug. 22, 2013.

(30) Foreign Application Priority Data
Aug. 30, 2012 (DE) 10 2012 215 407.8

(51) Int. Cl. G06F 3/01

(52) U.S. Cl. CPC G06F 3/013

(57) ABSTRACT

A method is provided for obtaining an input for an operating element from a plurality of operating elements, a function being assigned to each operating element. Each operating element is capable of being individually singled-out. The method determines an operating element, to which the user directs his/her gaze, from the plurality of operating elements, based on detecting the user's gaze and assigns the gaze to the determined operating element. The method singles-out the determined operating element. The method receives an input at an input device, and assigns the input to the function assigned to the determined operating element.

### CROSS REFERENCE TO RELATED APPLICATIONS

This application is a continuation of PCT International Application No. PCT/EP2013/067453, filed Aug. 22, 2013, which claims priority under 35 U.S.C. §119 from German Patent Application No. 10 2012 215 407.8, filed Aug. 30, 2012, the entire disclosures of which are herein expressly incorporated by reference.

### BACKGROUND AND SUMMARY OF THE INVENTION

The present invention relates to methods for providing an input for an operating element, appropriately designed devices, and motor vehicles having such devices.

Today, eye gaze detecting devices, also called eye trackers, which can aid in detecting the gaze and the line of sight of a person derived from the gaze, are known. Eye gaze detecting devices are used in various applications. In this regard, WO 93/14454 discloses the use of an eye gaze detecting device to change the location of a cursor on a computer screen.

The object of the present invention is to provide a method and a device that adapt to the operating inputs of a driver of a motor vehicle.

This and other objects are achieved by a method, device and correspondingly equipped vehicle, for providing an input for an operating element from a plurality of operating elements, wherein a function is assigned to each operating element. Each operating element can be individually singled-out. The method determines an operating element, to which the user directs his/her gaze, from a plurality of operating elements, based on detecting the user's gaze and assigns the gaze to an operating element; singles-out the specified operating element; receives an input at an input device; and assigns the input to the function assigned to the specified operating element.

Disclosed is a method for providing an input for an operating element from a plurality of operating elements, a function being assigned to each operating element, and each operating element being capable of being individually singled-out (highlighted), including: determining an operating element, to which the user directs his/her gaze, based on detecting the user's gaze and assigning the gaze to an operating element; singling-out the specified operating element; receiving an input at an input device; and assigning the input to the function assigned to the specified operating element.

In order to operate a function, the user thus leads his/her gaze to the operating element, for which he/she wishes to set or change a function. By singling-out the operating element, the user is provided feedback that his/her gaze has been recognized and the feedback given as to which operating element his/her eye gaze has been assigned. The user now may avert his/her gaze again from the operating element. Setting or changing the function then occurs via an input device.

Especially in the case of driving a motor vehicle, this allows for locating or arranging the input device in an ergonomically advantageous manner and in a manner that promotes road safety. A possible location for the central input device is, for example, at the steering wheel.

Compared to today's usual operation, the disclosed method makes a faster operation possible. Regarding the methods commonplace today, for example when operating non-locking keys in motor vehicles, an operating element is mainly detected by one's gaze and then one's hand or a finger has to be moved to the operating element, to which end eye contact with the operating element is maintained. Finally, the hand or the finger actuates the operating element or a setting is carried-out. The disclosed method offers the advantage that the central input device may be disposed so that the input device can be operated without looking, for example at the steering wheel, where it may easily be identified by touch. In this way, eye contact does not have to be averted from the traffic situation during the time of operation, which is otherwise necessary for moving the hand or the finger to the operating element. In the disclosed method, the operating element only has to be gazed at, which is in accordance with the first step of the operating method so far typical. The actual input for the function then may occur without looking, meaning that one's gaze only briefly has to be averted from the traffic situation.

A function may be a function of a motor vehicle, for example the specified indoor temperature for an air conditioner, a rear-window heater, the activation/deactivation of a radio output, etc. A plurality of operating elements refers to a group having two or more operating elements.

An input device may be a non-locking key or a switch, a wheel with locking positions, a continuously rotating wheel, a slide switch, a potentiometer or the like. Preferably, the respective functions of the operating elements from the plurality of operating elements may be operated advantageously using one type of input device, for example, the input device may be a non-locking key used for turning the radio output on/off and for the rear-window heater. A second input device for functions of a second plurality of operating elements, which are operated advantageously using a different type of input device, for example, a wheel with locking positions to regulate the indoor temperature and to set the interval length of windshield wipers in intermittent operation, may be provided.

An operating element may be a small display of a symbol indicating the assigned function. The display may be backlit, so that when activating the backlight the symbol illuminates. An example is a switch having a translucent symbol, which is backlit by an LED having an on-off function or by a small light bulb, so that the symbol situated in the switch illuminates and may be visible even in the dark. In addition, the operating element may also offer the opportunity to set a function, in particular using a mechanical operating device such as a switch or a wheel. On the other hand, the operating element may also only be the display of an element of a menu having multiple selectable elements on a display, for example, a list having text entries or areas specifically arranged and sized for eye contact that represent selection options. The operating element may also be a graphic element in a graphic illustration, for example, a traffic jam specifically marked on a map or an object in a photograph detected by way of object recognition.

The operating elements may be individually singled-out by backlighting, such as the backlit displays described above, in the case of displaying on screens also by changing color, providing a frame, or changing the size.

Detecting the user's gaze, and, therefore, carrying out the method, may be active permanently or be first activated by a user.

In some cases costs may be saved, namely then when multiple operating elements have the ability to be actuated, meaning that the operating elements are suitable for activating and deactivating or alternately may be replaced by fixedly defined operating elements and the input is carried-out exclusively via the input device.

In a further refinement, when determining another operating element from the plurality of operating elements, the input is also received at the input device.

Therefore, the input device centrally receives the inputs for all functions assigned to the operating element. In this manner, the further refinement allows for reducing the time one's gaze is averted for all functions of the plurality of operating elements, analogous to the explanation above.

Furthermore, the input for multiple functions is controlled at a central input device that may be situated in an ergonomically advantageous manner. In this way, all functions of the plurality of operating elements may be operated in an ergonomically advantageous manner. This is particularly advantageous because it often might not be possible to locate or arrange one input device for each function at a centrally and ergonomically advantageous location. This might not be possible in the case of a motor vehicle and for a particularly advantageous position of the input device, for example at the steering wheel, because of the limited opportunities to arrange an input device at the steering wheel. Furthermore, locating a plurality of non-locking keys at the steering wheel might complicate the simultaneous operation of functions, as well as the driving of the motor vehicle by the user.

Further, the user also profits from the opportunity to provide inputs for the input device for all functions of the plurality of operating elements without looking, if the input device is appropriately situated. Even when the central input device is not situated so that it may be operated without looking, the position for multiple functions remains the same. This is advantageous in that the hand and finger motions become well known based on learning effects and the hand-eye coordination for this motion is established. Therefore, the driver needs less time for positioning the hand or the finger for input into the central input device than he/she might need for positioning the hand or the finger for the respective operating element. To that effect, the time for averting the gaze from the traffic situation becomes shorter.

In other words, the method, in a special case of the further refinement, moreover includes determining a further operating element, to which the user directs his/her gaze, based on detecting the user's gaze and assigning the gaze to an operating element; singling-out the additionally specified operating element; receiving an additional input at the input device; and assigning the additional input to the function assigned to the additionally specified operating element. At a minimum, this special case has the same advantages as mentioned for the further refinement.

In a further refinement, the input device is singled-out in response to determining the operating element. This can be realized by backlighting the input device so that at the border of the input device a beam of light emerges, or also by using a translucent input device that is backlit. In this way, it is intuitively symbolized to the user how the next input process is to take place. This then is particularly advantageous, when multiple pluralities of operating elements, to each of which a different input device has been assigned, are defined. Depending on the plurality to which the operating element, determined by the user's gaze, belongs, one input device assigned to the plurality is singled-out.

In another further refinement, each operating element from the plurality of operating elements is a mechanical operating device, particularly a switch and, more particularly, a switch of a motor vehicle. The mechanical operating device, in particular, includes a symbol referencing the assigned function, and a backlight singling-out the symbol and, therefore, the operating element.

In an additional further refinement, the method includes receiving an input at the operating element and assigning the input to the function assigned to the operating element. In this way, the user is provided with an alternative input method; however, he/she may also enter an input into the operating element using the typical means. Providing this alternative approach allows people who are not familiar with or do not wish to use the system to have a choice in operating the functions.

In a further refinement, the method includes the following steps, which are carried-out before the method disclosed first: determining a second operating element to which the user directs his/her gaze, based on detecting the user's gaze and assigning the gaze to an operating element; singling-out the second specified operating element, until the operating element for which an input is to be selected is singled-out.

In this way, the user has the opportunity to go over the individual operating elements before he/she selects an input for the assigned function. The user continuously receives feedback for the operating elements specified by the system. Particularly in situations where the operating elements are not visible or are difficult to see, for example, at night in a darkened vehicle interior, the correct operating element may be selected. In this way, the darkening of the vehicle interior may be maintained because always only one or, when transitioning, two operating elements are lit and emit light.

Furthermore disclosed is a device including an eye gaze detecting system, a plurality of operating elements, each operating element being capable of being individually singled-out, an input device and an electronic processing unit, the device being designed to carry out one of the previously referenced methods or a further refinement of one of the previously referenced methods. Also, disclosed is a motor vehicle including the previously referenced device.

Furthermore disclosed is a method for providing an input for an operating element from a plurality of operating elements, each operating element being assigned a function, each operating element being capable of being singled-out individually, including: determining an operating element, to which the user directs his/her gaze, based on detecting the user's gaze and assigning the gaze to an operating element; singling-out the specified operating element; selecting a set of input gestures for the specified operating element; detecting the user's input gesture; determining whether the user's input gesture is part of the selected set of input gestures; and assigning the input gesture to a function assigned to the specified operating element. In this method, compared to the first disclosed method, the input is carried-out by a user's input gesture. Therefore, an input device is no longer required but, of course, may be provided as an option. The input gesture may be determined by methods known per se, for example, by recording a user or only the user's hands or arms using a camera and relevant image processing.

Compared to a gesture operation only known from the related art, the disclosed method has the advantage that the user sets or changes the function in a two-step operation. First, he/she selects the function to be changed by gazing at the operating element and then sets the function or changes the function via a gesture operation. This allows for using the same input for setting different functions. In other words, the same set of input gestures is selected for each operating element from the plurality of operating elements. This way, for example, the rear-window heater may be selected via eye contact. Using an input gesture for activation (for example, a downward motion of an extend finger), the rear-window heater may be activated. If the user, however, gazes at the operating element for driving stability systems and carries out the same input gesture for activation, the driving stability system is activated.

A set of input gestures may be made up of two gestures (for example, a downward and upward motion of an extended finger), but also of more gestures (for example, up, down, right, and left hand motions) for adjusting the side mirror.

A second plurality of operating elements may be provided, for which a second set of input gestures is selected. This way, functions sharing the same type of input gestures may be grouped together. For example, setting the indoor temperature and the interval length for windshield wipers may be assigned to a second plurality of operating elements. Both functions easily may be set using discrete values and, therefore, be operated using the same input gesture.

Moreover, in a further refinement, the method also includes: receiving an input at the operating element, and assigning an input to the function assigned to the operating element. In this way, an alternative input method is provided to the user; however, he/she may also enter an input into the operating element in the typical manner. Providing this alternative approach it is ensured that people who are not familiar with gesture detecting systems or who do not wish to use the system have a choice in operating the functions.

In an additional further refinement, the method includes the following steps, which are carried-out before the referenced steps: determining a second operating element, to which the user directs his/her gaze, based on detecting the user's gaze, and assigning the gaze to an operating element; singling-out the second specified operating element, until the operating element referenced first in the method is singled-out. In this way, the user has the opportunity to go over the individual operating elements before he/she selects an operating element for an input for the assigned function. The user continuously receives feedback for the operating elements specified by the system. Particularly in situations where the operating elements are not visible or are difficult to see, for example, at night in a darkened vehicle interior, the correct operating element may be selected. In this way, the darkening of the vehicle interior also may be maintained because always only one or, when transitioning, two operating elements are lit and emit light.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a simplified schematic representation of an exemplary embodiment of the present invention.

### DETAILED DESCRIPTION OF THE DRAWING

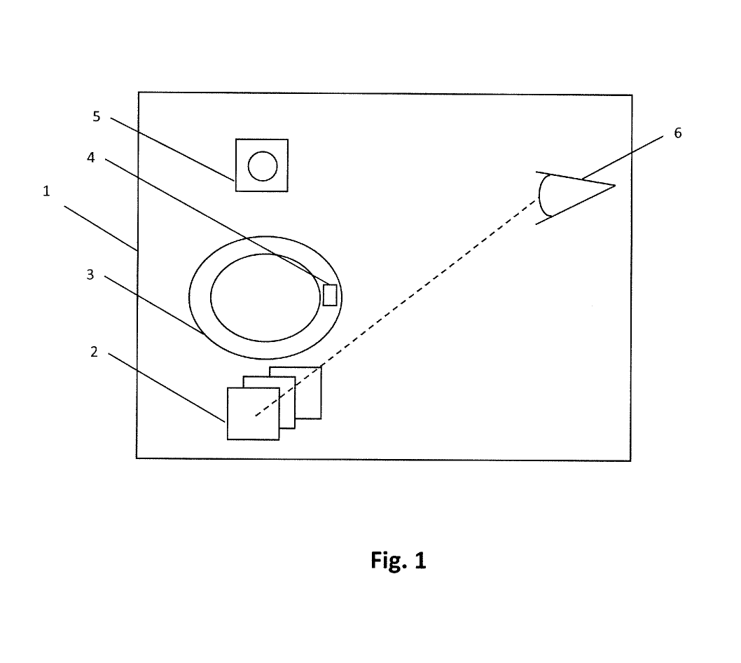

FIG. 1 shows schematically an interior 1 of a passenger car, which has an occupant (not shown). One eye 6 of a driver is shown. If the driver wishes to activate a specific function, here a rear-window heater, he/she gazes at switch 2 (that is, the operating element) as indicated by the corresponding dashed line. The function of rear-window heating is assigned to switch 2. FIG. 1 shows additional switches (without reference characters). Camera 5, which together with suitable electronic processing, forms an eye gaze detecting system, captures the driver's gaze. The gaze is assigned to switch 2, and switch 2 is then backlit by an LED, so that the assigned symbol for the rear-window heater illuminates and the driver is provided feedback that—and how—his gaze has been interpreted. Now, the driver may direct his/her gaze again to the traffic situation. The selection of switch 2 remains active for some time after averting one's gaze from switch 2, for example, for 1 s, 2 s, or 5 s. Non-locking key 4 at steering wheel 3 is backlit (more generally: singled-out (highlighted)) to symbolize to the driver that an input is possible via non-locking key 4. If the driver actuates non-locking key 4 at steering wheel 3 during this time, the rear-window heater is activated. The driver may proceed similarly in order to again deactivate the rear-window heater. After activating the rear-window heater, the LED of switch 2 illuminates steadily to indicate that the rear-window heater is activated.

When it is dark, it is often preferred that the interior of a passenger car is completely darkened to avoid glare. In this case, the driver may search for the required operating element using his/her gaze. Therefore, he/she lets his/her gaze sweep the area where he/she presumes the required operating element is located. Each switch at which he/she gazes is singled-out until he/she gazes at a new switch. In other words: as soon as the gaze moves to a next operating element or switch, the illumination of the previous switch extinguishes. In this way, the user may search the plurality of switches without having to turn on the complete interior lighting. The eye gaze detecting system is able to work continuously even when the interior is darkened, because it may work with the residual (still available) light or the light in the non-visible spectrum, such as infrared light. For this purpose, the driver is lit with a source of infrared light and it is recorded in this area of lighting. The switch gazed at last is then determined for input and the user may make an input for the function assigned for the switch via switch 4 at steering wheel 3.

In addition to the input via eye contact and switch 4 at steering wheel 3, the user also has the opportunity to operate switch 2 directly and to provide a setting for the assigned function.

In a further exemplary embodiment, the indoor temperature is to be turned up. The driver gazes at the temperature display on the dashboard of a passenger car. The gaze is detected and is assigned to the temperature display. The temperature display acknowledges the eye gaze detection by lighting up. At the same time, the applicable input device (for example, a thumb wheel or a rocker switch) lights up at the steering wheel and signals the connection, namely, that a temperature adjustment may be carried-out via the input device. The driver actuates the input device, here a thumb wheel and, for example, turns the temperature up. After gazing at the temperature display, the driver may redirect the gaze to the traffic situation. Thus, the averting of one's gaze from the traffic situation is minimized.

Likewise, an “afterglowing” of the gaze target (or of the operating element, here, the temperature display) is contemplated. The gaze target is just briefly fixated and the gaze may then return to the street (meaning, not move on to another gaze target). The gaze target for the setting via the input device at the steering wheel remains active for a certain time.

In a further exemplary embodiment, the noise level (or analogous, the sound quality settings such as bass, treble, fade, balance) or the airflow, or another analogous setting is to be changed. The user directs his/her gaze to a symbol for the sound level on the instrument panel or the instrument cluster. The symbol is determined by the eye gaze detection and backlit, indicating to the user that his/her selection has been detected. At the same time, the current sound volume is displayed on a display (for example on an LCD screen). An appropriate input device at the steering wheel is singled-out for input, for example by backlighting the circumference of the input device. The driver now may change the sound level using the input device.

In a further exemplary embodiment, a specific radio station is to be set. To this end, a display, for example an LCD or OLED screen in the center console of a passenger car, shows a list having stations. The driver directs his/her gaze to the desired station, which is recognized by the eye gaze detecting device. The station is specified as a station, to which the user directs his/her gaze, and singled-out by a graphic highlight, for example, by framing or check-marking the station. The selection may now be confirmed via a non-locking key at the steering wheel. The selection is forwarded to the radio. Alternatively, the driver may confirm the selection by a gesture, for example, by raising one's hand or a nod, which may be detected by tracking the eye position. The gesture is detected by a gesture detection, which may be based on camera recordings. For this purpose, the camera recordings of the eye gaze detection may be used.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for providing an input for an operating element from a plurality of operating elements, wherein a function is assigned to each operating element, the method comprising the acts of:
determining, via an eye gaze detecting device, an operating element to which a user directs his/her gaze from a plurality of operating elements, and assigning the gaze to the determined operating element;
singling-out the determined operating element, wherein each of the plurality of operating elements are individually capable of being singled-out;
receiving, at an input device, an input of the user; and
assigning the received input to the function assigned to the determined operating element.

2. The method according to claim 1, wherein the input received at the input device is also assigned to a function assigned to another operating element determined from the plurality of operating elements.

3. The method according to claim 1, further comprising the acts of:
determining, via the eye gaze detecting device, a further operating element to which the user directs his/her gaze, and assigning the user's gaze to the further operating element;
singling-out the further determined operating element;
receiving, at the input device, an additional input of the user; and
assigning the additional input to the function assigned to the further determined operating element.

4. The method according to claim 1, wherein each of the plurality of operating elements is a mechanical operating device.

5. The method according to claim 4, wherein the mechanical operating device is a switch of a motor vehicle.

6. The method according to claim 4, wherein the mechanical operating device comprises a symbol associated with the assigned function, and further wherein the symbol is backlit to single-out the operating element.

7. The method according to claim 1, further comprising the acts of:
receiving, at the operating element, an input of the user; and
assigning the input received at the operating element to the function assigned to the operating element.

8. The method according to claim 1, wherein the method further comprises initially the acts of:
determining, via the eye gaze detecting device, a second operating element to which the user directs his/her gaze, and assigning the gaze to the second operating element; and
singling-out the second determining operating element until the method singles-out the determined first operating element.

9. A motor vehicle, comprising:
a plurality of operating elements, each operating element having a function of the vehicle assigned thereto, wherein each operating element is able to be individually singled-out;
an input device configured to receive inputs of a user of the motor vehicle;
an eye gaze detecting device configured to detect to which of the plurality of operating elements the user of the motor vehicle is directing his/her gaze; and
an electronic processing unit coupled to the eye gaze detecting device, input device and the plurality of operating elements, the electronic processing unit executing a program to:
determine, via an eye gaze detecting device, an operating element to which a user directs his/her gaze from a plurality of operating elements, and assign the gaze to the determined operating element;
single-out the determined operating element;
receive, at the input device, an input of the user; and
assign the received input to the function assigned to the determined operating element.

10. A method for providing an input for an operating element from a plurality of operating elements, wherein a function is assigned to each operating element, the method comprising the acts of:
determining, via an eye gaze detecting system, an operating element of the plurality of operating elements to which a user directs his/her gaze, and assigning the gaze to the determined operating element;
singling-out the determined operating element;
selecting a set of user input gestures for the determined operating element;
detecting an input gesture of the user;
determining whether the detected input gesture of the user is one input gesture from the selected set of input gestures; and
assigning the input gesture to the function assigned to the determined operating element when the input gesture is an input gesture from the selected set of gestures.

11. The method according to claim 10, further comprising the acts of:
receiving, at the operating element, an input of the user; and
assigning the received input at the operating element to the function assigned to the operating element.

12. The method according to claim 10, further comprising the initial acts of:
determining, via the gaze detecting device, a second operating element of the plurality of operating elements to which the user is directing his/her gaze, and assigning the gaze to the determined second operating element; and
singling-out the determined second operating element until the method singles-out the determined first operating element.
